(19) United States
(12) Patent Application Publication
(10) Pub. No.: US 2006/0155717 A1
(43) Pub. Date: Jul. 13, 2006

(54) Device and method for producing computer readable formatted output

(76) Inventors: Neil Davis, Stockton, CA (US); Bill L. Welch, Mt. View, CA (US); Robert J. Hoevenaar, Amsterdam (NL); Michael J. Robb, San Jose, CA (US); Brad R. Lewis, Gilroy, CA (US)

Correspondence Address: MCDERMOTT WILL & EMERY LLP, 600 13TH STREET, N.W., WASHINGTON, DC, 20005-3096, US

(21) Appl. No.: 11/023,984

(22) Filed: Dec. 29, 2004

(51) Int. Cl. G06F 7/00

(52) U.S. Cl. 707/100

(57) ABSTRACT

Communication device for supporting a general-purpose computer to communicate with a vehicle having a control unit for controlling at least one particular function of the vehicle. A first request in XML format for requesting the control unit to return specified information is received from the computer. The request received is converted into a request in control unit specific format and is sent to the control unit of the vehicle. When a reply in control unit specific format including the specified information is received from the vehicle, the reply is also converted into a reply in XML format. The converted reply is sent to the computer.

### TECHNICAL FIELD

Embodiments described below relate generally to a device and method for producing a computer readable formatted output from particular system specific format data. Specifically, the embodiments relate to a device and method for communicating with a vehicle having a control unit for controlling at least one particular function of the vehicle, in which information in control unit specific format obtained from the control unit is converted into information in tag-based markup language format so that a general-purpose computer can read the information without proprietary hardware and software.

### DESCRIPTION OF RELATED ART

The automotive industry has desired electronic control units to be an integral part of diagnostic equipment, a need addressed by development of proprietary hardware and software to communicate with those units. A typical proprietary device for the diagnostic process employs processors with unique display devices in which language or protocol specific to an electronic control unit is used. Being proprietary usually prevents a diagnostic device and its software from being portable or scalable. The subject matter described herein addresses that shortcoming.

### SUMMARY OF THE DISCLOSURE

Embodiments detailed herein describe a device and method for communicating with a vehicle having a control unit for controlling at least one particular function of the vehicle in which the device and method produce a general-purpose computer readable formatted output. In one aspect of the disclosure, a device includes a first interface configured for receiving first information in control unit specific format from the control unit, the first information relating to the at least one particular function. A converter is provided for converting the first information into second information in tag-based markup language format. The device also includes a second interface configured for sending the second information to an external terminal.

In another aspect of the disclosure, the device includes conversion information used for converting first information in control unit specific format into second information in computer readable format. Embodiments described below include as the conversion information a conversion database including, but not limited to, lookup tables and/or formulas for the conversion. A converter is configured for retrieving information corresponding to the first information from the conversion database to convert the first information into the second information.

In yet another aspect of the disclosure, a device includes first and second interfaces. The first interface is configured for receiving from an external terminal a first request in tag-based markup language format for requesting the control unit to provide specified information to the terminal, and sending to the terminal a first reply in tag-based markup language format including the specified information. The second interface is also configured for sending to the control unit a second request in control unit specific format corresponding to the first request, and receiving from the control unit a second reply in control unit specific format corresponding to the first reply. The device further includes a converter configured for converting the first request into the second request to output the converted request to the second interface, and converting the second reply into the first reply to output the converted reply to the first interface.

In one embodiment, the device may include conversion information used for converting the first request into the second request and for converting the second reply into the first reply. Embodiments described below include as the conversion information a conversion database including, but not limited to, lookup tables and/or formulas for the conversion. When converting the first request into the second request and converting the second reply into the first reply, the converter retrieves information corresponding to the first request and the second reply from the conversion database, respectively. Specifically, the converter may analyze the first request according to tags in the first request, and retrieve the corresponding data from the conversion database based on the analysis.

The first interface may be configured for wirelessly connecting the device to the terminal, or configured for connecting the device to the terminal through a universal serial bus (USB).

Additional aspects and advantages of the present disclosure will become readily apparent to those skilled in this art from the following detailed description, wherein only exemplary embodiments of the present disclosure is shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

Examples of the subject matter claimed herein are illustrated in the figures of the accompanying drawings and in which like reference numerals refer to similar elements and in which:

FIG. 1 is a schematic diagram showing a basic configuration of one embodiment of the disclosure.

FIG. 2 is a block diagram showing a control unit in a vehicle according to an embodiment of the disclosure.

FIG. 3 is a block diagram showing a communication device according to an embodiment of the disclosure.

FIG. 4 is a block diagram showing a host computer according to an embodiment of the disclosure.

FIG. 5 is a diagram explaining processes performed by executing instructions by a processor in host computer according to an embodiment of the disclosure.

FIG. 6 is a diagram explaining processes performed by executing instructions by a processor in the communication device according to an embodiment of the disclosure.

FIG. 7 is a flow chart showing a method for communicating with a vehicle performed by the host computer according to an embodiment of the disclosure.

FIG. 8 is a flow chart showing a process performed in step 710 in FIG. 7 in more detail.

FIG. 9 is an example of a request in an XML format.

FIG. 10 is a flow chat showing a method for supporting communication with a vehicle performed by the communication device according to an embodiment of the disclosure.

FIG. 11 is a flow chart showing a process performed in step 1002 in FIG. 10 in more detail.

FIG. 12 is a flow chart showing a process performed in step 1008 in FIG. 10 in more detail.

FIG. 13 is an example of a reply in an XML format according to an embodiment of the disclosure.

FIG. 14 is an example of a display image on a display of the host computer.

FIG. 15 is a diagram explaining processes performed by executing instructions by a processor in the communication device according to an alternative embodiment of the disclosure.

FIG. 16 is a diagram explaining processes performed by executing instructions by a processor in the host computer according to an alternative embodiment of the disclosure.

FIG. 17 is a schematic diagram showing a basic configuration of an alternative embodiment of the disclosure.

FIG. 18 is a block diagram showing a computer according to an alternative embodiment of the disclosure.

FIG. 19 is a diagram explaining processes performed by executing instructions by a processor in the computer according to an alternative embodiment of the disclosure.

### DESCRIPTION OF THE EMBODIMENT

The present disclosure is now described in more detail with reference to the accompanying figures, in which several embodiments are shown. The embodiments may be applied to any systems having a control unit for controlling at least one particular function of the system. For example, the systems may include or be utilized with any appropriate engine having an appropriate voltage source, such as a battery, an alternator and the like, providing any appropriate voltage, such as about 12 Volts, about 42 Volts and the like. The engine may comprise items utilizing fossil fuels, such as gasoline and diesel, natural gas, propane and the like, electricity, such as that generated by battery, magneto, solar cell and the like, wind and hybrids or combinations thereof. Examples of the systems may include an automobile, a truck, a boat or ship, a motorcycle, a generator, an airplane and the like. One skilled in the art will recognize that the systems are not limited to the above examples, and the embodiments described herein can be applied to any systems as long as they include a control unit for controlling at least one particular function of the system.

One skilled in the art will recognize that methods, apparatus, systems, data structures, and computer readable media implement the features, functionalities, or modes of usage described herein. For instance, an apparatus embodiment can perform the corresponding steps or acts of a method embodiment.

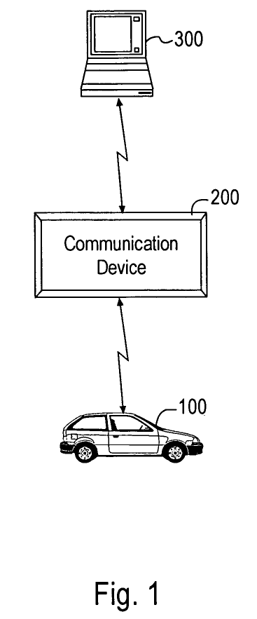

FIG. 1 is a schematic diagram showing a basic configuration of one embodiment of the disclosure. The illustrated embodiment includes a vehicle 100, a communication device 200 and a host computer 300.

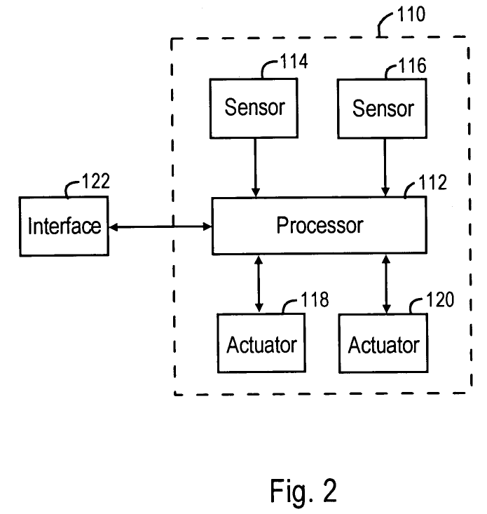

Vehicle 100 includes various electronic control units. FIG. 2 is a block diagram showing an example of a control unit. A control unit 110 includes a processor 112 receiving outputs from sensors 114, 116 to control actuators 118, 120. Processor 112 is also configured for communicating with an external device, such as communication device 200, through an interface 122. Unless otherwise specified, a control unit includes any controllers and processors in a vehicle, such as electric control unit (ECU), an on-board computer, and OBD based diagnosing and monitoring units in this disclosure.

Typically, control units within vehicle 100 may control various systems and/or subsystems such as an engine, a transmission, a brake, steering mechanism, and an air conditioner. Depending on a vehicle, control units may use various different communication protocols and data formats.

For example, an engine control unit receives a plurality of input signals. These input signals may include a coolant temperature sensor, an oxygen sensor, an intake manifold pressure sensor, a vehicle speed sensor, an accelerator switch, a throttle position sensor, a neutral switch and an engine speed sensor. The engine control unit receives and processes input signals received from the various sensors and switches. In response to these input signals, the engine control unit may output various control signals. These control signals may control a canister purge solenoid, an exhaust gas recirculation (EGR) system actuator, an idling control actuator, an ignition coil and/or a plurality of fuel injections.

Since a control unit, such as the above-mentioned engine control unit, employs a data format specific to the unit, communication device 200 acts as a middleman when host computer 300 communicates with vehicle 100. Communication device 200 is configured to be adapted to any vehicle for communication. Communication device 200 is also configured for converting data in computer readable format into data in control unit readable format, and vise versa so that both vehicle 100 (control unit) and host computer 300 can read data created by the other, and communicate with each other. In one embodiment, communication device 200 is configured to receive data in tag-based markup language format from host computer 300, convert data in control unit specific format, and vise versa. A tag-based markup language format includes a set of tags which go with data and describe what the data is supposed to be. Examples of tag-based markup languages are Hypertext Markup Language (HTML) and Extensible Markup Language (XML). For the purpose of illustration, in this disclosure, an XML format is assumed to be employed to perform communication between host computer 300 and communication device 200 so that host computer 300 can communicate with vehicle 100. For example, the numeral “85” can be recognized as a temperature by a computer if “85” is placed between the following XML tag pair: <Temperature>85</Temperature>. The “/” in the second tag signifies that the data description for that temperature data is complete. Other tag pairs may follow, describing and giving values of other data elements.

Returning to FIG. 1, communication device 200 and host computer 300 can communicate with each other through a wireless network. Various protocols or signaling techniques can be used for the wireless communication. Example wireless protocols include local area protocols such as Ethernet (e.g., 802.11a, 802.11b, 802.11g), Bluetooth, and infrared. Other wireless protocols include cellular-based protocols, such as CDMA, GSM, or GPRS, or satellite-based protocols. Wireless signals communicated between communication device 200 and host computer 300 can be encrypted to ensure data privacy. Persons skilled in the art will appreciate that many suitable encryption technologies can be implemented in this embodiment. For example, in an 802.11 environment, WiFi Protected Access (WPA) can be used. Further, authorization codes or encryption can be used to prevent unauthorized use of communication device 200.

In another embodiment, communication device 200 and host computer 300 can communicate with each other through a wireline network. Communication device 200 can be connected to host computer 300 by, for example, a universal serial bus (USB).

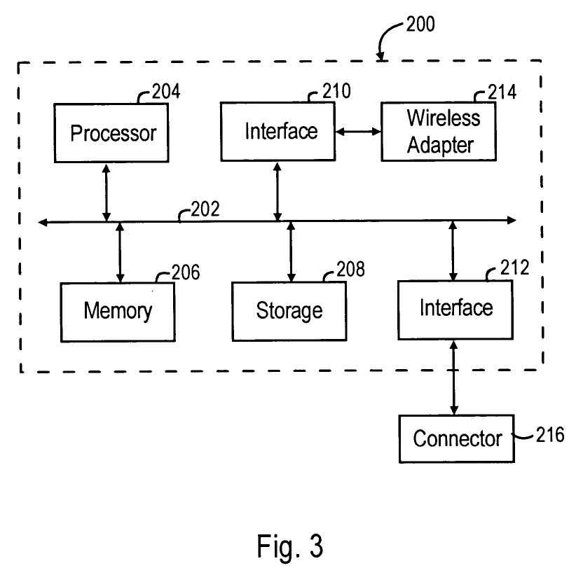

FIG. 3 is a block diagram showing communication device 200 according to an embodiment of this disclosure. Communication device 200 in this disclosure includes a bus 202, at least one processor 204, a memory 206, storage 208, interfaces 210, 212, a wireless adapter 214 and a connector 216. In one embodiment, communication device 200 can be portable and powered by a battery. In this instance, processor 204 or other circuitry may be designed for low power operation of the battery. In a typical service facility, satisfactory runtime is approximately eight hours or the duration of a technician's shift.

Bus 202 operatively couples each of processor 204, memory 206, storage 208 and interfaces 210, 212.

Processor 204 executes instructions or program code modules from memory 206. According to one embodiment of this disclosure, a data format conversion is provided by communication device 200 by executing one or more sequences of one or more data conversion instructions contained in memory 206. Such instructions may be read into memory 206 from another computer-readable medium including storage 208. Execution of the sequences of the data conversion instructions contained in memory 206 causes processor 204 to perform the process steps described below. One or more processors in a multi-processing arrangement may also be employed to execute the sequences of instructions contained in memory 206. In alternative embodiments, hard-wired circuitry may be used in place of or in combination with software instructions to implement embodiments of this disclosure. Thus, embodiments of the disclosure are not limited to any specific combination of hardware circuitry and software.

The term “computer-readable medium” as used herein refers to any medium that participates in providing instructions to processor 204 or other processors for execution. Such a medium may take many forms, including but not limited to, non-volatile media, volatile media, and transmission media. Non-volatile media include, for example, optical or magnetic disks. Volatile media include dynamic memory. Transmission media include coaxial cables, copper wire and fiber optics, including the wires that comprise bus 202. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM, a DVD, any other optical medium, punch cards, paper tape, any other physical medium with patterns of holes, a RAM, a PROM, and EPROM, a FLASH-EPROM, any other memory chip or cartridge, a carrier wave, or any other medium from which a computer can read.

Interface 210 provides bidirectional data communication with host computer 300. In one embodiment, interface 210 provides one or more external data ports for receiving data in XML format from and sending it to host computer 300 in the form of electrical, radio frequency, or optical signal. Interface 210 is coupled to wireless adaptor 214 which is, in tern, coupled to host computer 300 with a wireless communication signal.

Interface 212 is coupled to vehicle 100 through connector 216 which is electrically connected to a corresponding connector of the vehicle. In one embodiment, interface 212 includes analog-to-digital (A/D) converters or other logic for sampling input signals from vehicle 100 and providing those signals to processor 204.

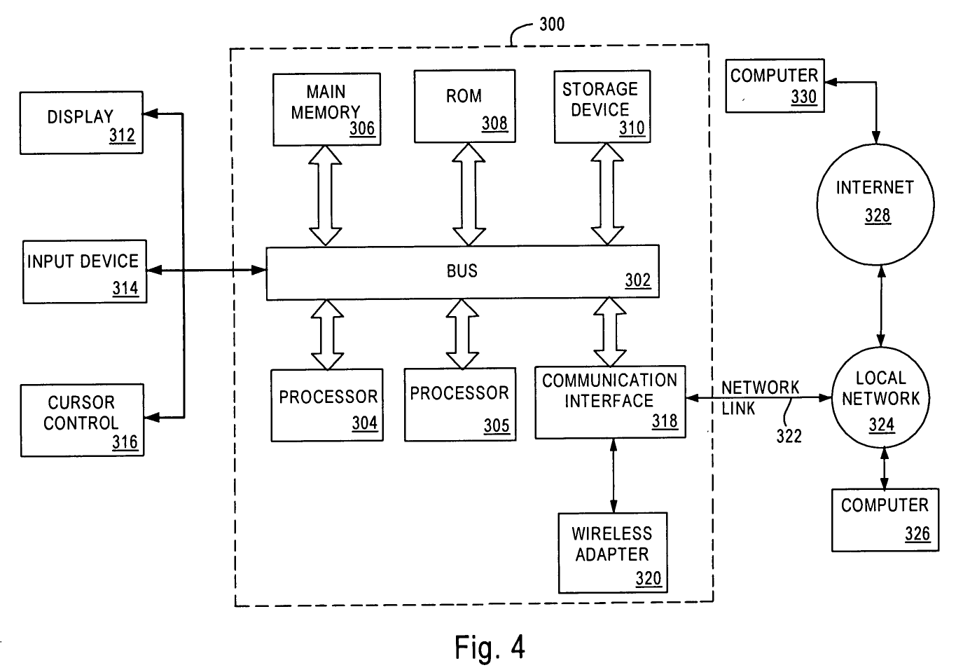

FIG. 4 is a block diagram showing host computer 300 according to an embodiment of this disclosure. Host computer 300 includes a bus 302 or other communication mechanism for communicating information, and a processor 304 coupled with bus 302 for processing information. Host computer 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Host computer 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions including an instruction for communicating with communication device 200. Additional processor 305 may be employed for multi-processing to execute the sequence of instructions contained in main memory 306.

Host computer 300 may be coupled via bus 302 to a display 312, such as a cathode ray tube (CRT) or a liquid crystal display (LCD), for displaying information to a service technician. An input device 314, including alphanumeric and other keys, is coupled to bus 302 for communicating information and command selections to processor 304. Another type of user input device is a cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Host computer 300 also includes a communication interface 318 coupled to bus 302. Communication interface 318 provides a two-way data communication coupling to a wireless adaptor 320 wirelessly coupled to communication device 200 to exchange data in XML format.

Communication interface 318 may also be coupled to a network link 322 that is connected to a local area network 324. For example, communication interface 318 may include a local area network (LAN) card to provide a data communication connection to a compatible LAN. As another example, communication interface 318 may include an integrated services digital network (ISDN) or a modem to provide a data communication connection to a corresponding type of telephone line. Wireless links may also be implemented. In any such implementation, communication interface 318 is configured for sending and receiving electrical, electromagnetic or optical signals that carry digital data streams representing various types of information.

Network link 322 typically provides data communication through one or more networks to other data devices. For example, network link 322 may provide a connection through local network 324 to a computer 326. Local network 324 is, in turn, connected to the internet 328 to which a computer 330 is connected. Local network 324 and internet 328 both use electronic, electromagnetic or optical signals that carry digital data streams.

Host computer 300 can send data to, and receive data from, computers 326, 330 through network link 322. Host computer 300 may be configured for performing an authentication procedure to allow computers 326, 330 to obtain information from vehicle 100, or sending the information to the computers, for example, by way of e-mail.

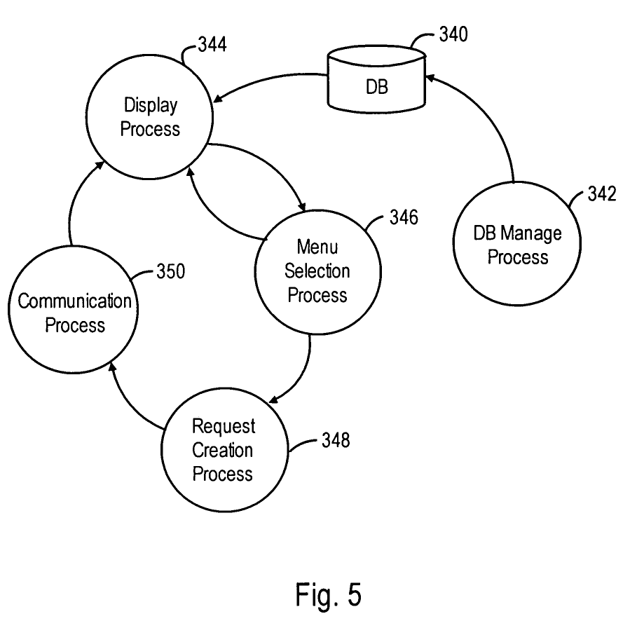

FIG. 5 is a diagram explaining processes performed by executing instructions for communicating with a vehicle by processor 304 in host computer 300 according to an embodiment of the disclosure. Host computer 300 has a database (DB) 340 containing a selection menu in XML format, which includes, for example, make and model of vehicles, and information able to be obtained regarding control units in each vehicle. Database 400 can be stored in storage device 310. Since the selection menu is of XML format, an internet browser, such as a Microsoft Explorer, or an Opera Web Browser together with input device 314 or cursor control 316, may be used to perform the processes shown in FIG. 5. Processes that an internet browser does not support may be implemented, for example, in the form of a “plug-in.” The instructions may include a DB (database) managing process 342 for updating database 340.

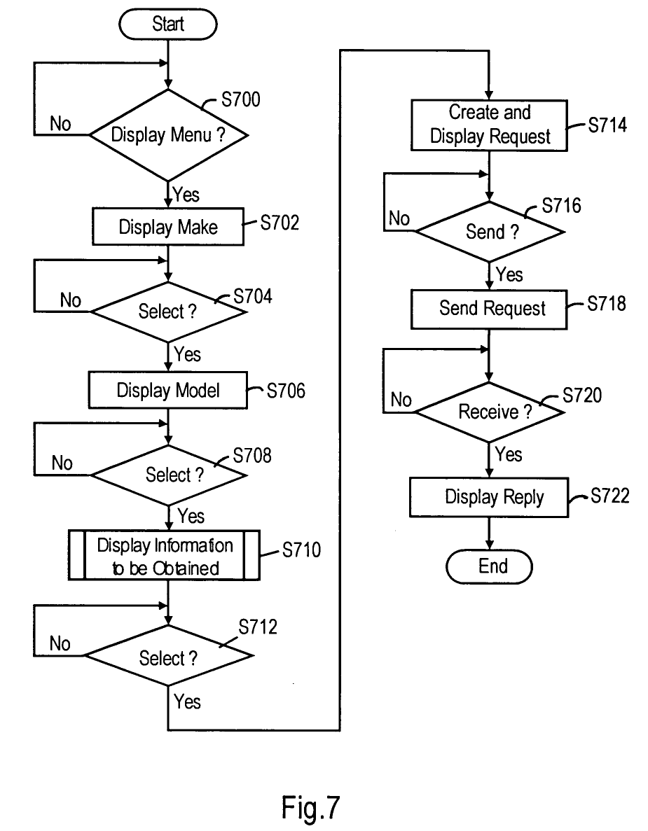

A display process 344 displays a selection menu on display 312 of host computer 300 for a service technician's selection. A menu selection process 346, controlled by input device 314 or courser control 316, selects information from the selection menu, and then, a request creation process 348 creates a request in XML format based on the information selected by menu selection process 346. For example, since the selection menu has an XML format, a request in XML format may be created by gathering selected information with XML “tags” (see FIGS. 7-9 as described below).

In this embodiment, three types of requests may be created. Request type I is for obtaining parameters, for instance, an output of a sensor in a control unit. Request type II is for activating a control device to test its particular function to obtain a test result. Request type III is for requesting a control device to return an error code when, for example, a particular function does not work properly.

A communication process 350 transmits the request created by request creation process 348 to communication device 200 and waits for a reply in XML format from the device. When receiving the reply by communication process 350, display process 344 displays the reply on display 312 for a service technician at host computer 300.

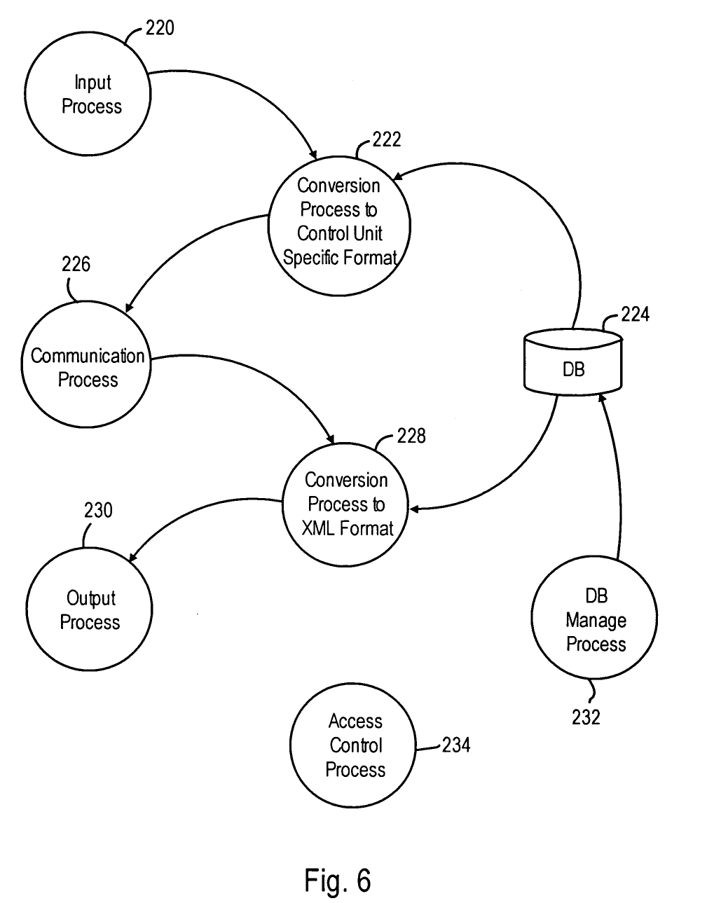

FIG. 6 is a diagram explaining processes performed by executing instructions for communicating with a vehicle in memory 206 by processor 204 in communication device 200. The instructions may be read out from storage 208 into memory 206 shown in FIG. 3.

An input process 220 monitors receipt of a request in XML format from host computer 300. A conversion process to control unit specific format 222 receives the request in XML format through input process 220 and converts the request in XML format to a request in control unit specific format based on conversion information in a database (DB) 224. Database 224 may include any information for converting a request in XML format into a request in control unit specific format so that a target control unit can read the request. In one embodiment, database 224 comprises lookup tables and/or formulas for the conversion. Communication device 200 may include database 224 in storage 208 and also have a DB (database) manage process 232 for updating database 224.

Once receiving a request in XML format from host computer 300, conversion process 222 retrieves from database 224 conversion data corresponding to the request received, and converts the request into a request in control unit specific format.

A communication process 226 receives the converted request from conversion process 222, sends it to vehicle 100 and waits for a reply in control unit specific format from the vehicle. Once receiving a reply in control unit specific format from vehicle 100, communication process 226 provides the reply to a conversion process to XML format 228.

Conversion process 228, when receiving a reply in control specific format, retrieves conversion data corresponding to the received reply from database 224. Database 224 may also includes any information (e.g., lookup tables and/or formulas) for converting a reply in control unit specific format into a reply in XML format. In accordance with a lookup table or formula retrieved, conversion process 228 converts the received reply in control unit specific format into a reply in XML format so that host computer 300 can read the reply. An output process 230 receives the converted reply in XML format, and transmits it to host computer 300.

The instructions may further include an access control process 234 for performing an authentication procedure to allow host computer 300 to access communication device 200.

In the following, an operation of communication device 200 and host computer 300 will be described in more detail with reference to flow charts. FIG. 7 is a flow chart showing a method for communicating with vehicle 100 performed by host computer 300. The illustrated method begins with obtaining a selection menu from database 340 in FIG. 5. Upon a service technician's instruction (step 700: Yes), a list of manufacturers of vehicles (make) is displayed (step 702).

When a manufacturer is selected (step 704: Yes), models of the selected manufacturer are displayed for section (step 706). When the service technician selects a model and year of a vehicle (step 708: Yes), a list of information possible to be obtained from the selected vehicle is shown (step 710) and the service technician selects desired information from the list (step 712: Yes).

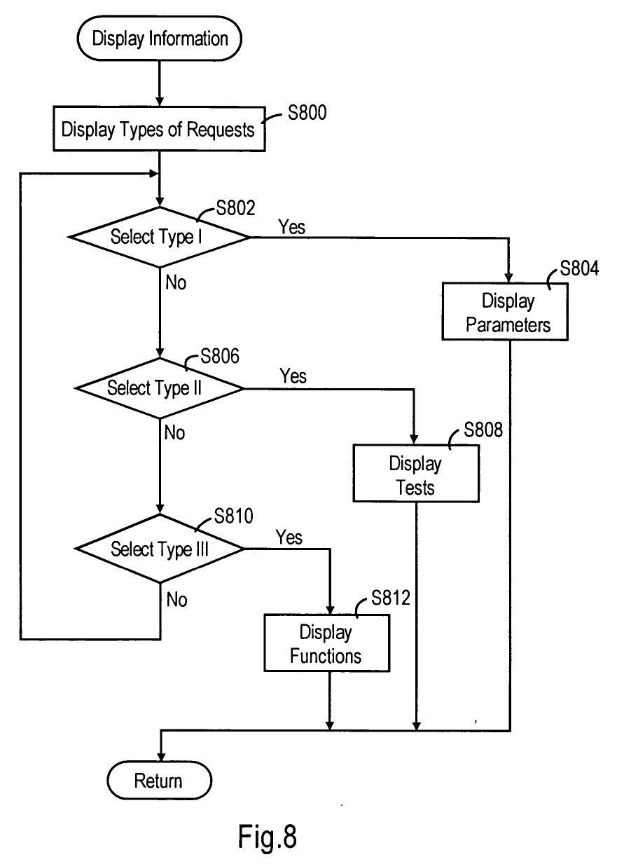

FIG. 8 is a flow chart showing a process in step 710 of FIG. 7 in more detail. First, three types of requests such as type I, type II and type III are displayed for selection (step 800). As explained above, type I is a request to obtain a certain parameter or parameters, type II is a request to activate a control unit to test a particular function, and type III is a request to obtain an error code from a control unit in which a function monitored by the control unit is considered to have a problem.

When the service technician selects type I (step 802: Yes), its relevant information is retrieved from database 340 to display parameters to be selected (step 804). For example, in-car temperature, ambient temperature and so forth are shown as the parameters.

If type I is not selected, but type II is selected (step 806: Yes), a list of tests to be able to perform in the selected vehicle is displayed (step 808). Further, if type I and type II are not selected, but type III is selected (step 810: Yes), a list of functions of the selected vehicle is displayed for specifying at least one of the functions to obtain an error code (step 812).

Returning to FIG. 7, when the service technician selects, for example, type I and particular parameters (step 712: Yes), a request in XML format is created (step 714). The request created may be displayed on display 312 for the service technician's confirmation.

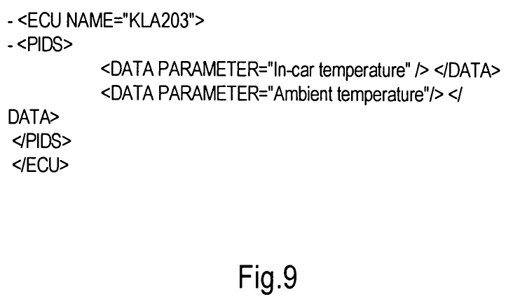

By way of an example, it is assumed that the service technician selects type I, and in-car temperature and ambient temperature as the parameters. FIG. 9 is an example of a request in XML format. In FIG. 9, an XML tag “ECU NAME” is for specifying an electronic control unit (“ECU”). Here, a climate control unit “KLA203” is designated.

The XML tag “PIDS” stands for a parameter identification showing that type I is selected by a service technician. The XML tag “DATA PARAMETER” is for designating a particular parameter selected by the service technician. In FIG. 9, in-car temperature and ambient temperature are selected and are shown between “DATA PARAMETER” tags, respectively.

Returning again to FIG. 7, based upon the technician's instruction of sending the request created (step 716: Yes), the request in XML format is sent to communication device 200 (step 718). After sending the request, reception of a reply from communication device 200 is monitored (step 720). When receiving a reply (step 720: Yes), the reply is displayed on display 312 (step 722). As disclosed below, the format of a reply has already been converted into an XML format, and the reply can be readily displayed on display 312 of host computer 300.

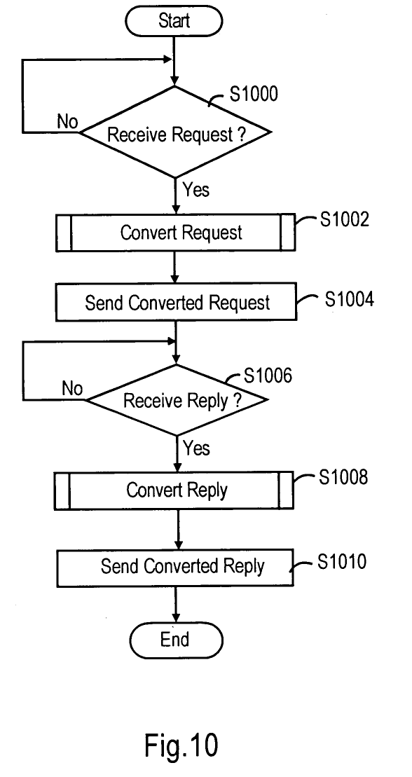

FIG. 10 is a flow chart showing a method for supporting communication with a vehicle performed by communication device 200. The method illustrated begins with receiving a request in XML format from host computer 300 (step 1000). When receiving the request (step 1000: Yes), the received request in XML format is converted into a request in control unit specific format (step 1002).

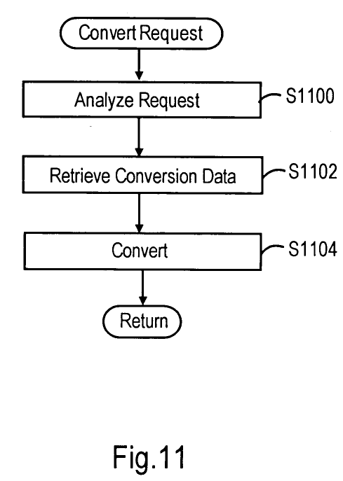

FIG. 11 is a flow chart showing a process performed in step 1002 in FIG. 10 in more detail. Before a conversion process is performed, the request in XML format is analyzed to obtain a content of the request according to XML “tags” (step 1100). As shown in FIG. 9, since the XML formatted request includes XML tags, the structure of the request can be analyzed based on the tags, and the contents of the request can be identified. For example, when receiving the request shown in FIG. 9, based on its XML tags, a target control unit can be identified as “KLA203” (climate control unit), and the parameters requested are identified as in-car temperature and ambient-temperature. Based on the information obtained from the request, necessary data for converting the format of the request and for communicating with the control unit “KLA203” (climate control unit) can be obtained from database 224 (FIG. 6).

According to the analysis in step 1100, conversion data corresponding to the request is retrieved from database 224 (step 1102). Then, the request in XML format is converted into a request in control unit specific format based on the conversion data retrieved. For example, when a request received instructs communication device 200 to obtain parameters as shown in FIG. 9, a converted request in control unit specific format includes a command code and a request for address bytes specifying a location of the parameters in the target control unit. When the request received is type II or type III which activates a control unit to test a particular function or requests a control unit to return an error code, a request in control unit specific format may include a command code requesting a control unit to conduct testing or to return an error code.

Returning to FIG. 10, the converted request is sent to vehicle 100 (step 1004). In vehicle 100, a target control unit, responsive to the request, returns necessary information such as parameters, test results or error codes in accordance with a command code in the request.

When a reply in control unit specific format is received from vehicle 100 (step 1006: Yes), the received reply is converted into a reply in XML format in order for host computer 300 to read it (step 1008).

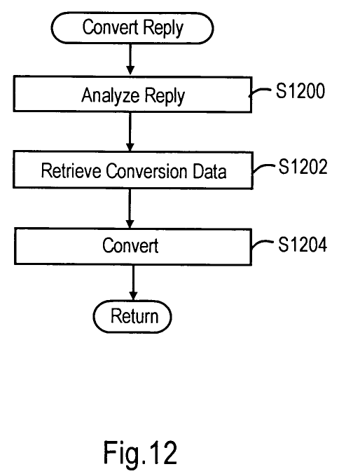

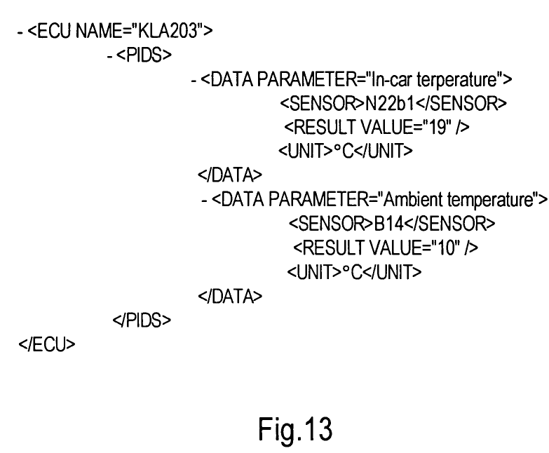

FIG. 12 is a flow chart showing a process performed in step 1008 in FIG. 10 in more detail. The reply received is analyzed (step 1200) and conversion data corresponding to the reply is retrieved from database 224 (step 1202). For example, the reply to the request shown in FIG. 9 includes information regarding in-car temperature and ambient temperature in the form of address bytes. Based on the analysis of the reply, a corresponding look-up table or formula is retrieved from database 224, and the address bytes are converted into actual temperature data (step 1204). FIG. 13 is an example of a reply in XML format responding to the request shown in FIG. 9. The reply shown in FIG. 13 includes information regarding sensors which detect in-car temperature and ambient temperature, and in-car temperature and ambient temperature detected by the sensors.

In FIG. 12, there is step 1202 for retrieving conversion data corresponding to a reply from database 224. However, this step may be skipped. Conversion data necessary to convert a reply from vehicle 100 can be anticipated when a request in XML format is analyzed. Therefore, conversion data to be used in step 1204 may previously be obtained in step 1102 of FIG. 11.

Returning again to FIG. 10, after the reply in control unit format is converted into the reply in XML format, the converted reply is sent to host computer 300 through the wireless connection (step 1010).

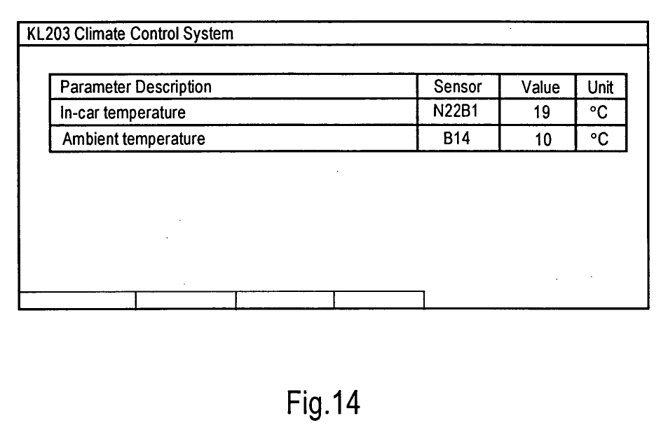

At host computer 300, the reply in XML format is displayed on display 312 (see step 722 in FIG. 7). FIG. 14 is an example of a display image on display 312 of host computer 300, showing in-car temperature and ambient temperature obtained from the climate control unit in vehicle 100.

In the above embodiment, host computer 300 has database 340 providing the selection menu to a service technician to create a request in XML format to be sent to communication device 200. However, a service technician can create a request without using the selection menu by using XML tags. In addition, host computer 300 may provide a template for creating a request, in which a service technician can fill necessary information.

### Alternative Embodiment 1

In the above described embodiment, host computer 300 has database 340 in FIG. 5 containing the selection menu so that a service technician can create a request in XML format by selecting information provided by the menu. In an alternative embodiment, the selection menu may be stored in a database in communication device 200, not in host computer 300. When host computer 300 creates a request in XML format, the computer accesses the database in communication device 200 to obtain a selection menu and create the request.

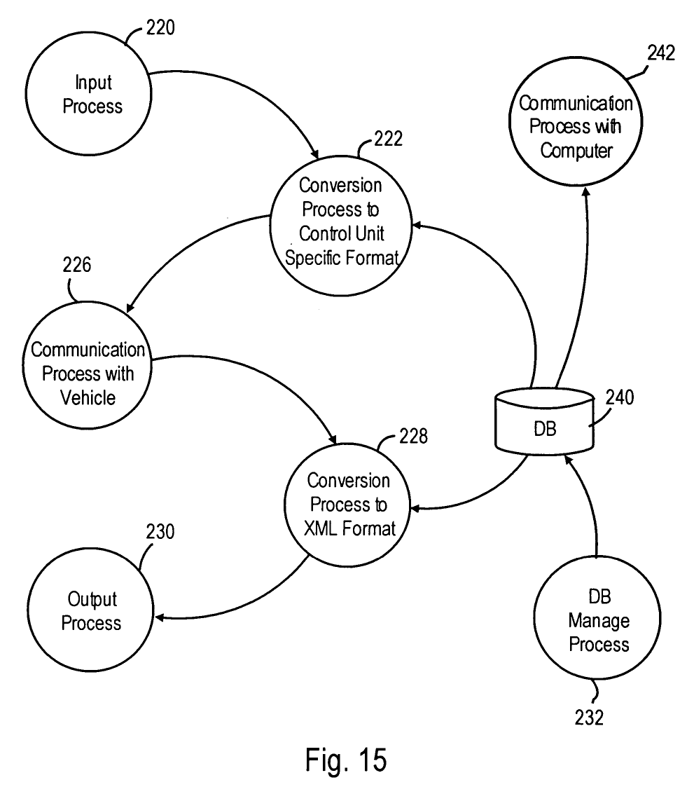

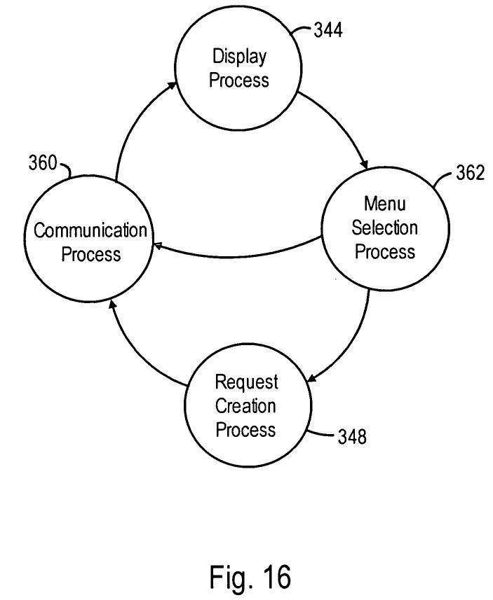

FIG. 15 is a diagram explaining processes performed by executing instructions by a processor in communication device 200, and FIG. 16 is a diagram explaining processes performed by executing instructions by a processor in host computer 300. Persons skilled in the art will understand that hardware of communication device 200 and host computer 300 can be configured in the same manner as shown in FIGS. 3 and 4.

Communication device 200 includes a database (DB) 240 containing conversion data and a selection menu in XML format (see FIG. 15). A communication process with computer 242 is provided to allow host computer 300 to access database 240 and obtain the selection menu. Other processes, such as input, output, conversion, communication and DB manage, are equivalent to those described with reference to FIG. 6.

In creating a request in XML format in host computer 300 (see FIG. 16), communication process 360 accesses database 240 in communication device 200 to obtain a selection menu, and display process 344 displays the menu on display 312. Depending on menu selection by menu selection process 362, communication process 360 accesses database 240 to obtain, for example, more detailed selection menu. Request creation process 348, as described above, creates a request in XML format according to selection by menu selection process 362.

Person skilled in the art will understand that a method for communicating with vehicle 100 performed by communication device 200 and host computer 300 is the same as that described based on FIGS. 7-14 except for host computer's accessing communication device's database to obtain a selection menu.

### Alternative Embodiment 2

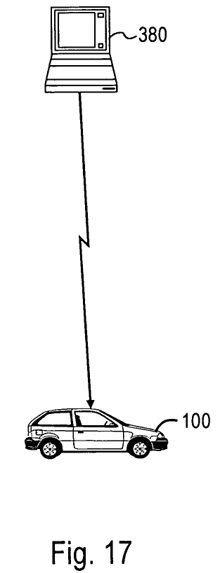

In the embodiment described above, host computer 300 and communication device 200 are independent of each other. In this alternative embodiment, there is a computer 380 configured for performing all the functions that communication device 200 and host computer 300 can provide. FIG. 17 shows a basic configuration of this embodiment. Computer 380 may directly be connected to vehicle 100.

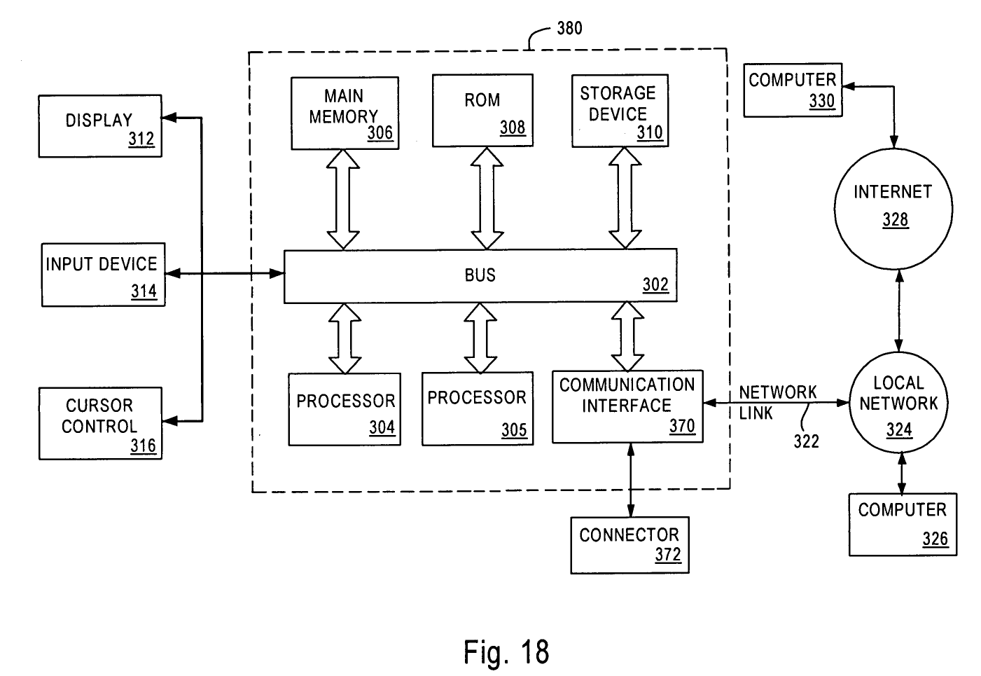

FIG. 18 is a block diagram showing computer 380. Computer 380 has the same hardware configuration as computer 300 shown in FIG. 4 except that communication interface 370 has a connector 372 for establishing connection to vehicle 100. Therefore, an explanation of the configuration of computer 380 is omitted for brevity. Computer 380 can send data to, and receive data from, computers 326, 330 through network link 322. Computer 380 is configured for performing an authentication procedure to allow computers 326, 330 to obtain information from vehicle 100.

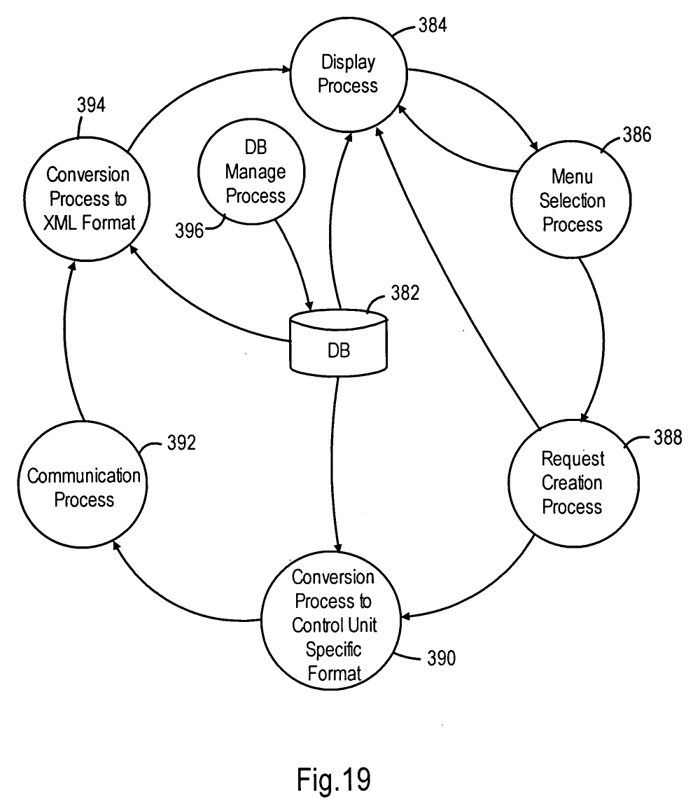

FIG. 19 is a diagram explaining processes performed by executing instructions by processor 304 (or processors 304, 305) in computer 380. A database (DB) 382, stored in, for example, storage device 310, contains conversion data to be used when a request in XML format is converted into a request in control unit specific format, and a reply in control unit specific format into a request in XML format. Database 382 further contains a selection menu in XML format, which includes, for example, make and model of vehicles, and information to be able to obtain from the respective vehicles (information regarding control units in each vehicle). A display process 384 displays the selection menu on display 312 of computer 380 for service technician's selection. The selection menu is in XML format, as described above. Computer 380 may have a DB (database) manage process 396 for updating database 382.

A menu selection process 386, working together with input device 314 or cursor control 316, selects information from the selection menu, and then, a request creation process 388 creates a request in XML format based on the information selected by menu selection process 386. There are, for example, three types of requests: obtaining parameters, performing a test, and obtaining an error code, as described above.

A conversion process to control unit specific format 390 receives the request from request creation process 388 and converts it into a request in control unit specific format based on conversion data in database 382.

A communication process 392 receives the converted request from conversion process 390, sends it to, and waits for a reply from, vehicle 100. Since a reply from vehicle 100 also has a format specific to a control unit, the reply needs to be converted into a reply in XML format. When receiving a reply from vehicle 100, communication process 392 provides the reply to a conversion process to XML format 394. Conversion process 394, when receiving the reply, retrieves conversion data corresponding to the received reply from the database 382, and converts the reply in control unit specific format into a reply in XML format. The converted reply is provided to display process 384 and is displayed on display 312, as shown in FIG. 18.

Computer 380 can send the reply to, for example, computer 326 or 330 through network link 322. Alternatively, computer 326 or 330 may access computer 380 to obtain the reply. In such a case, communication process 392 may provide an authentication procedure to allow computer 326 or 330 to access computer 380.

A detailed explanation of a method for communicating with vehicle 100 performed by computer 380 is omitted for brevity. Persons skilled in the art will understand that the method in this alternative embodiment is made clear by referring to FIGS. 7-14, although there is no need in this embodiment to perform steps of sending a request to communication device 200 from host computer 300 and sending a reply to host computer 300 from communication device 200.

Having described embodiments, it is noted that modifications and variations can be made by persons skilled in the art in light of the above teachings. It is therefore to be understood that changes may be made in the particular embodiments disclosed that are within the scope and sprit of the disclosure as defined by the appended claims and equivalents.

What is claimed is:

1. A device for supporting communication with a vehicle having a control unit for controlling at least one particular function of the vehicle, comprising:
a first interface configured for receiving first information in control unit specific format from the control unit, the first information relating to the at least one particular function;
a converter configured for converting the first information into second information in a tag-based markup language format; and
a second interface configured for sending the second information to an external terminal.

2. The device according to claim 1, further comprising
a conversion database including conversion data used for converting the first information into the second information, wherein
the converter is configured for retrieving conversion data corresponding to the first information from the conversion database when converting the first information into the second information.

3. A device for supporting communication with a vehicle having a control unit for controlling at least one particular function of the system, comprising:
a first interface configured for receiving first information in control unit specific format from the control unit, the first information relating to the at least one particular function;
a conversion database including conversion data used for converting the first information into second information in computer readable format;
a converter configured for retrieving conversion data corresponding to the first information from the conversion database to convert the first information into the second information; and
a second interface configured for sending the second information to an external terminal.

4. A device for supporting communication with a vehicle having a control unit for controlling at least one particular function of the vehicle, comprising:
a first interface configured for receiving from an external terminal a first request in tag-based markup language format for requesting the control unit to provide specified information to the terminal, and sending to the terminal a first reply in tag-based markup language format including the specified information;
a second interface configured for sending to the control unit a second request in control unit specific format corresponding to the first request, and receiving from the control unit a second reply in control unit specific format corresponding to the first reply; and
a converter configured for converting the first request into the second request to output the converted request to the second interface, and converting the second reply into the first reply to output the converted reply to the first interface.

5. The device according to claim 4, wherein
the converter is configured for analyzing the first request according to tags in the first request to convert the first request into the second request.

6. The device according to claim 4, further comprising
a conversion database including conversion data used for converting the first request into the second request and for converting the second reply into the first reply, wherein
the converter is configured for retrieving conversion data corresponding to the first request and the second reply from the conversion database, respectively, to convert the first request into the second request and convert the second reply into the first reply.

7. The device according to claim 6, wherein
the converter is configured for analyzing the first request according to tags in the first request;
retrieving the corresponding conversion data from the conversion database based on the analysis; and
converting the first request into the second request based on the data retrieved.

8. The device according to claim 6, wherein
the conversion database includes at least one of a lookup table and a formula.

9. The device according to claim 4, wherein
the first interface is configured for wirelessly connecting the device to the terminal.

10. The device according to claim 4, wherein
the first interface is configured for connecting the device to the terminal through a universal serial bus (USB).

11. The device according to claim 4, wherein
the control unit is configured for controlling the particular function based on an output of a sensor, and
the first request is designed for obtaining the output of the sensor.

12. The device according to claim 4, wherein
the first request is designed for activating the control unit to test the particular function to obtain a result of the test.

13. The device according to claim 4, wherein
the first request is designed for requesting the control unit to return an error code.

14. The device according to claim 4, wherein
the tag-based markup language format is extensible markup language (XML).

15. A method for communicating with a system having a control unit for controlling at least one particular function of the system, comprising the steps of:
receiving first information in control unit specific format from the control unit, the first information relating to the at least one particular function;
converting the first information into second information in tag-based markup language format; and
sending the second information to an external terminal.
